(19) United States
(12) Patent Application Publication
(10) Pub. No.: US 2026/0084095 A1
(43) Pub. Date: Mar. 26, 2026

(54) Hydrophobic Alkyl-Ester Physical Solvents for CO2 Removal from H2 Produced from Synthesis Gas

(71) Applicant: United States Department of Energy, Washington, DC (US)

(72) Inventors: Jeffrey T. Culp, Wexford, PA (US); Wei Shi, Pittsburgh, PA (US); Robert L. Thompson, Pittsburgh, PA (US); Surya P. Tiwari, Pittsburgh, PA (US); Kevin P. Resnik, White Oak, PA (US); Lei Hong, Pittsburgh, PA (US); Janice A. Steckel, Pittsburgh, PA (US); David Hopkinson, Morgantown, PA (US); Nicholas Siefert, Jefferson Hills, PA (US)

(21) Appl. No.: 19/397,134

(22) Filed: Nov. 21, 2025

Related U.S. Application Data
(63) Continuation-in-part of application No. 17/867,094, filed on Jul. 18, 2022.
(60) Provisional application No. 63/223,422, filed on Jul. 19, 2021.

(51) Int. Cl. B01D 53/14

(52) U.S. Cl. CPC B01D 53/1475; B01D 53/1412; B01D 53/1425; B01D 2252/205; B01D 2256/16; B01D 2256/20; B01D 2257/504

(57) ABSTRACT

One or more embodiments relate to a method for removing CO₂ from a gaseous stream containing CO₂ having the steps of contacting the gaseous stream containing CO₂ with a solvent at a first temperature and a first pressure to dissolve said CO₂ in said solvent, where the solvent is made up of at least one ester, and where said at least one ester has two or more alkyl-ester functional groups on a central hydrocarbon chain.

### CROSS-REFERENCE TO RELATED APPLICATIONS

This Utility patent application claims priority benefit as a continuation in part of U.S. Non-Provisional patent application Ser. No. 17/867,094, filed Jul. 18, 2022, which in turn claims the benefit as a U.S. Non-Provisional of U.S. Provisional Patent Application Ser. No. 63/223,422, filed on Jul. 19, 2021, currently pending, the entirety of which is incorporated by reference herein.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to hydrophobic, low viscosity, low vapor pressure physical solvents for carbon capture. More specifically embodiments relate to a method of separating CO₂ from a gas stream using a solvent having two or more ester groups.

### BACKGROUND

Future integrated gasification combined cycle (IGCC) power plants and steam methane reforming (SMR) chemical plants can generate high pressure CO₂ gas streams generated from the in-situ water-gas shift reaction to produce H₂, which when burned for energy, does not create any long-lasting greenhouse gas emissions. Because of the high CO₂ partial pressure in the gas stream (such as 20 bar) emitted from IGCC and SMR plants, the driving force for CO₂ to be absorbed from the gas stream to the solvent phase is large compared with post-combustion carbon capture, which has a very low CO₂ partial pressures of only 0.1 bar in the gas stream. In addition, the high pressure of CO₂ will make a physical solvent viable because a chemical solvent will become inefficient mainly due to its extremely high regeneration energy compared with physical solvents. In contrast, CO₂ interaction with a physical solvent does not involve a chemical reaction. As a result, it will not need extensive energy to regenerate physical solvent.

A variety of methods have been proposed to capture CO₂ from high pressure syngas (i.e. precombustion CO₂ capture), including physical solvents, sorbents, and separation membranes, with continuous solvent looping systems currently being the most advanced. All commercially-available solvents for precombustion CO₂ capture are operated below room temperature because they are hydrophilic and, unless they are operated at low temperature, absorbed water reduces the ability to dissolve CO₂. Additionally, current state of the art CO₂ solvents have appreciably high vapor pressures at room temperature that would lead to sizable loss of the solvent through evaporation. Hence, a major limitation of current commercially-available solvent processes for precombustion CO₂ capture is that the solvents are operated below room temperature in order to (a) condense water before the absorption step in order to prevent water accumulation in the solvent, and (b) reduced solvent evaporation due to the sizable room temperature vapor pressure. Since these commercially-available solvents are used below room temperature, processes using such solvents are unable to make effective use of waste heat in the process in order to reduce the electricity consumption.

For example, if a physical solvent could be regenerated at higher temperature and pressure (40° C. and 10 bar vs 10° C. and 1 bar), the electricity consumption of CO₂ compression would be reduced approximately in half because the electricity required to isothermally compress CO₂ from 1 bar to 10 is approximately half of the electricity to isothermally compress CO₂ from 1 bar to 150 bar. By operating at below room temperature, a conventional hydrophilic solvent with high vapor pressure is unable to accept waste heat and therefore unable to reduce the electricity consumption associated with compressing CO₂ to the pressure needed to transport supercritical CO₂ in pipelines. The presently designed hydrophobic solvents with low vapor pressure, conversely, allows for higher temperature and pressure operations (including accepting waste heat) and enable significant reduction in the cost of CO₂ capture from precombustion capture applications, such as but not limited to IGCC-CCS and SMR-CCS.

Pre-combustion capture of CO₂, capture of CO₂ from gas streams after generation of syngas but prior to delivery to a turbine, is typically accomplished using physical solvents as opposed to the more energy intensive aqueous amine chemisorption processes necessary for post-combustion CO₂ capture. Such amine chemisorption processes are more energy intensive because they require sufficient energy to break chemical bonds between CO₂ and the solvent molecules and release the captured CO₂ and regenerate the solvent. Physical solvent processes, conversely, require much less energy for regeneration because CO₂ interaction with physical solvent does not involve covalent bonds but only involves weaker van der Waals and electrostatic interactions. Physical solvents are preferable to chemical solvents/sorbents due to their low regeneration energy and are often used to absorb CO₂ from precombustion streams.

Precombustion CO₂ capture typically occurs after a water gas shift (WGS) reaction in order to increase the CO₂ and H₂ composition of a gaseous stream and to decrease the CO composition. While precombustion CO₂ capture could occur without the use of WGS reaction, this is not typically done because (a) the goal of low-GHG chemical/power plants is to generate/combust hydrogen, (b) WGS will increase the partial pressure of CO₂ in the syngas, and (c) the selectivity of CO₂ to H₂ is typically larger than the selectivity of CO₂ to CO in physical solvents. Typical WGS pre-combustion fuel gas streams consist of 30-32% CO₂, 43% H₂, 23% H₂O, 3% other gases such as CO, COS, H₂S and the total gas stream pressure is about 50 bar

Current state-of-the-art CO₂ capture solvents for pre-combustion processes, such as IGCC systems, are listed in FIG. 1. As the data in FIG. 1 demonstrates, physical solvent processes predominantly employ hydrophilic physical solvents such as AIR LIQUIDE GLOBAL E&C SOLUTIONS GERMANY GMBH's PURISOL® brand N-methyl pyrrolidone solvent (“NMP” hereinafter), PC Corporation's FLUOR® brand propylene carbonate solvent (“PC” hereinafter), or UNION CARBIDE CORPORATION's SELEXOL® brand dimethyl ethers of polyethylene glycol solvent (“DEPG” hereinafter) These solvents preferentially absorb CO₂, sulfur compounds, and water from a syngas mixture. Since the current commercial physical solvents touted for IGCC CO₂ capture were originally designed for removing acid gases from raw natural gas streams and to ensure that the gas meets pipelines specifications on sulfur content, heating value and dew point cleanup, they were designed to remove significant amounts of water along with the sour gas from the process gas. As such, the original focus of the aforementioned commercial solvents and the processes that employ them was on the purification of process gas without concern for the generation of high purity CO₂ streams suitable for CO₂ pipeline transmission and subsequent sequestration. In fact, the captured CO₂ is vented to the atmosphere in the commercially-available processes.

While water removal is important for natural gas pipeline applications, it is not favorable for applications in which the fuel stream is directly combusted onsite, as would be the case in IGCC systems. For CO₂ capture and sequestration, high uptake of water by the solvent is detrimental in several ways. One of the biggest detriments of water uptake by the solvent is reduced CO₂ uptake capacity. Computational modeling results indicate that CO₂ capacity and CO₂/H₂ selectivity of the DEPG is negatively impacted by co-absorption of water due to the stronger binding energy of water for the ether oxygens of that composition. Other reasons that water uptake by the solvent is detrimental for the IGCC system include reduced purity of the captured CO₂ stream and the need for lower temperatures for the capture process, the equipment corrosion due to water absorption in the solvent.

Existing commercial CO₂ solvents, while possessing some advantages, also have disadvantages. For example, PC and NMP can be operated at lower temperatures than DEPG without experiencing viscosity increases or forming slurries. DEPG, however, possesses superior thermal stability over PC and NMP, which allows removal of H₂O by thermal swing processes at elevated temperatures. These results suggest that a hydrophobic solvent with otherwise similar physical properties and CO₂ capacity to DEPG would outperform PC, NMP, and DEPG.

FIG. 1 provides a table of physical properties for commonly-used physical solvents for CO₂ removal from gas streams showing their relatively large water affinities. The data from FIG. 1 is prepared from Burr et al., “Which physical solvent is best for acid gas removal?” Hydrocarbon Processing, 2009, vol. 88, iss. 1, pp 43-50, the entirety of which is incorporated by reference herein.

As DEPG and other commercial solvents are hydrophilic, water accumulation over time in those solvents will greatly reduce their efficiency. In processes using those solvents, the moisture content of the water saturated pre-combustion gas stream needs to be addressed before the CO₂ capture step and/or the water-laden solvent needs to be stripped of water at elevated temperatures and then re-cooled prior to contacting the CO₂ solvent.

As shown in FIG. 1, NMP has a higher vapor pressure than DEPG which results in a significant amount of solvent vaporization during thermal regeneration and water removal. Of the three hydrophilic commercial solvents listed in FIG. 1, PC is the least hydrophilic of the three, but still takes up a significant amount of water. Further, PC cannot be stripped of absorbed water at high temperature because it is unstable in humid CO₂ above 60° C. to 65° C. Water mitigation in PC therefore needs to be accomplished prior to CO₂ capture, such as by using ethylene glycol along with an additional vacuum stripping step to regenerate the solvent. These water mitigation requirements significantly reduce the CO₂ capture efficiency using the hydrophilic solvents, add complexity to a system needing these water mitigation steps, and most crucially, can prevent the use of waste heat to lower regeneration costs if the water mitigation step requires operating the solvent at room temperature.

Water laden solvent can also add energy penalties and equipment costs to CO₂ absorbing processes by (a) requiring additional drying of the recovered CO₂ prior to pipeline transport, (b) removing water from the pre-combustion fuel gas stream which is needed as an energy-generation source in the combustion turbine, (c) increasing the solvent density and viscosity of DEPG due to water absorption which increases energy demands for pumping the solvent and adds to the absorber size due to slower CO₂ mass transfer rates, and (d) increasing corrosion rates requiring more expensive stainless steel materials. All the above-described disadvantages of current commercial CO₂ sorbents can be minimized using hydrophobic, low vapor pressure, and low viscosity solvents which do not tend to take up water. An ideal physical solvent would absorb as much CO₂ and as little H₂O and H₂ as possible for efficient capture of CO₂.

Thus, there is a need in the art for hydrophobic CO₂ solvents that can perform better than current state-of-the-art-hydrophilic solvents. The hydrophobic ester-based solvents disclosed herein are demonstrated to have physical properties and CO₂ uptake which are highly competitive with PC while having lower water absorption. This combination of high CO₂ absorption capacity, the ability to run at a range of room to warm temperatures, and reduced water uptake provide key advantages in applications where water does not need to be removed from the treated gas in order to meet pipeline specification, e.g. IGCC CO₂ capture in which the syngas is combusted onsite.

### SUMMARY

One object of at least one embodiment of the present invention is related to providing a method for separating CO₂ from a gaseous stream using a physical solvent. In an embodiment, the solvent is at least one ester, and wherein said at least one ester comprises two or more alkyl-ester functional groups on a central hydrocarbon chain. The utilized solvents are hydrophobic, operable over a wide range of temperature and pressures, have low vapor pressure and low viscosity, and are non-corrosive.

The solvents identified can be used as physical solvents for the separation of CO₂ from synthesis gas mixtures in carbon capture processes. These solvents can be structurally tuned or blended to possess the optimal physical parameters (viscosity, volatility, density, melting point) for the particular process to be employed, while maintaining high CO₂ loading capacity, high CO₂/H₂ solubility selectivity, and a low tendency to absorb water.

The invention provides a method for removing CO₂ from a gaseous stream containing CO₂ comprising: contacting the gaseous stream containing CO₂ with a solvent at a first temperature and a first pressure to dissolve said CO₂ in said solvent, wherein the solvent is at least one ester, and wherein said at least one ester comprises two or more alkyl-ester functional groups on a central hydrocarbon chain.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a table of properties taken from the literature for commercially used CO₂ solvents, in accordance with the features of the present invention;

FIG. 2 is a simplified schematic of a system for contacting a gaseous stream containing CO₂ from a source with a physical CO₂ solvent, in accordance with the features of the present invention;

FIG. 3 depicts the generic structures for hydrophobic esters for use as solvents for CO₂ in a gaseous stream, in accordance with the features of the present invention;

FIG. 4 is a flow chart of a method for using hydrophobic esters as a solvent for CO₂ capture from a gaseous stream, in accordance with the features of the present invention;

FIG. 5 depicts the structures of several hydrophobic esters suitable as solvents for CO₂ in a gaseous stream, in accordance with the features of the present invention;

FIG. 6 depicts the structures of particular diesters tested for suitability as solvents for CO₂ in a gaseous stream, in accordance with the features of the present invention;

FIG. 7A is a table of working capacities at 10° C. for various diester CO₂ solvents described herein as well as two commercial solvents, in accordance with the features of the present invention;

FIG. 7B is a plot showing Henry's Law constants listed in the literature for various commercial CO₂ solvents, in accordance with the features of the present invention;

FIG. 7C is a plot showing Henry's Law constants at 25° C. for various diester CO₂ solvents described herein, in accordance with the features of the present invention;

FIG. 8 is a plot showing the volumetric CO₂ uptake of diethyl adipate (CASSH-4) as a function of pressure at various temperatures as well as the volumetric CO₂ uptake of diethyl succinate (CASSH-5) measured at 0° C., as well as diethyl glutarate (CASSH-6), and DEPG both measured at 10° C., in accordance with the features of the present invention;

FIG. 9 is a plot of Henry's Law constants at 25° C. as a function of moles of ester functional group per liter of the diesters shown in FIG. 5, in accordance with the features of the present invention;

FIG. 10 is a table summarizing physical properties and CO₂ solubility parameters for ester CO₂ solvents as compared to commercial solvents, in accordance with the features of the present invention

FIG. 11A is a plot of the saturated water capacity at 25° C. for various CO₂ solvents, in accordance with the features of the present invention;

FIG. 11B is a table of water solubility values for moderately hydrophilic CO₂ solvents at 25° C., in accordance with the features of the present invention;

FIG. 11C is a table of H₂O capacity values for various diester CO₂ solvents, in accordance with the features of the present invention;

12A is a plot of gravimetric water absorption from humidified N₂ at 25° C., in accordance with the features of the present invention;

FIG. 12B is a plot of mass change over time in solvent as feed gas is switched at time zero from dry CO₂ to humified CO₂ at 1 bar and 10° C., in accordance with the features of the present invention;

FIG. 13 is a plot of weight change of DEPG stored in humidified N₂ over 30 hours, in accordance with the feature of the present invention;

FIG. 14 is a plot of low temperature isotherms for CO₂ dissolved in various diester solvents as a function of pressure at 0° C., in accordance with the features of the present invention;

FIG. 15A depicts the generic structures of multi-ester (more than two) CO₂ solvents, with FIG. 15B showing R groups for the generic structures of FIG. 15A, wherein TMP is an acronym for trimethylopropane esters, and wherein TME is an acronym for trimethylolethane esters, in accordance with the features of the present invention;

FIG. 15C is a table of molecular weights for various ester CO₂ solvents, in accordance with the features of the present invention;

FIG. 16 is a plot of Henry's Law constants at 40° C. as a function of molar concentration of ester group for various ester CO₂ solvents, in accordance with the features of the present invention;

FIG. 17A is a plot of water uptake over time at various relative humidities at 25° C. for DEPG, in accordance with the features of the present invention;

FIG. 17B is a plot of water uptake as a function of relative humidity for various ester CO₂ solvent and a commercial CO₂ solvent, in accordance with the features of the present invention;

FIG. 18 is a plot of CO₂ absorption as a function of pressure at 40° C. for various ester CO₂ solvents and various commercial CO₂ solvents, in accordance with the features of the present invention;

FIG. 19 is a table showing corrosion rates measured for carbon and stainless steels in various solvents, in accordance with the features of the present invention; and

FIG. 20 is a plot showing relative corrosion rates of C1020 carbon steel in the presence of various solvents, in accordance with the features of the present invention.

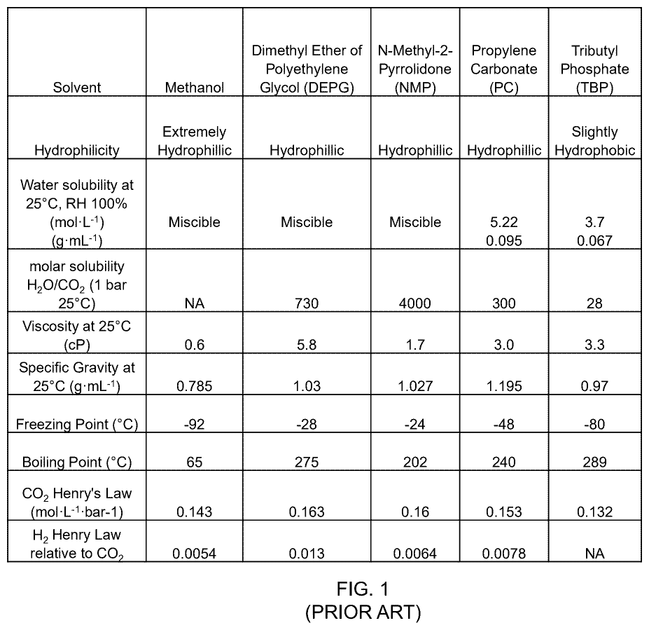

### DETAILED DESCRIPTION

The foregoing summary, as well as the following detailed description of certain embodiments of the present invention, will be better understood when read in conjunction with the appended drawings.

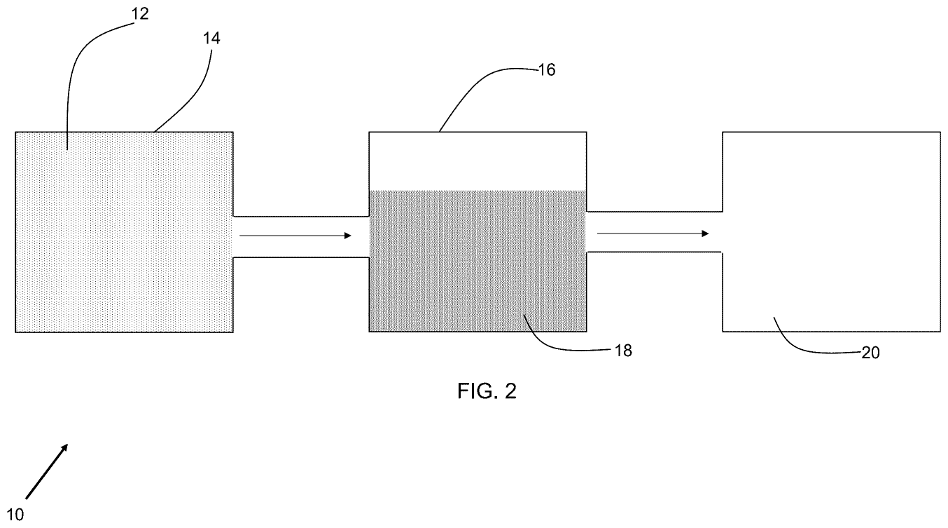

FIG. 2 depicts a simplified schematic of a system 10 to be used with the present invention. As shown in FIG. 2 the system 10 comprises a gaseous stream 12 eluting from a source 14, wherein the gaseous stream 12 flows from the source 14 (flow direction indicated with arrows) and into an absorber vessel 16 containing a solvent 18. Said source 14 is in reversible fluid communication with and upstream from said absorber vessel 16. In an embodiment, the gaseous stream 12 flows into the absorber vessel 16 through the solvent 18. The absorber vessel 16 is in reversible fluid communication with and upstream from a combustion module 20.

In an embodiment, the gaseous stream 12 comprises any stream of gasses containing CO₂. Exemplary gaseous streams 12 comprise products from a syngas-generating process eluting from the source 14. In an embodiment, the products from a syngas-generating process comprise H₂, CO₂, and H₂O and represent a syngas stream (combination of H₂ and CO) that has been through a water gas shift reaction. Where the gaseous stream comprises products from a syngas-generating process, the components can be present in any proportion, with typical compositions comprising between approximately 10 mol % and approximately 70 mol % H₂, and between approximately 20 mol % and approximately 80 mol % CO₂, where the stream is saturated with water. Where the syngas products have not gone through the water gas shift reaction CO will be present, with CO₂ and H₂O present in lower amounts than in post-WGS reaction streams.

In an embodiment, the source 14 is any source of CO₂, syngas, or combinations thereof. Exemplary sources include solid fuel gasification plants (IGCC) with the solid fuel being coal, biomass, or solid waste partially oxidized using either air or pure oxygen. Further exemplary sources include natural gas steam methane reforming SMR plants, and/or petroleum refineries reforming gaseous or liquid fuels into hydrogen and carbon dioxide.

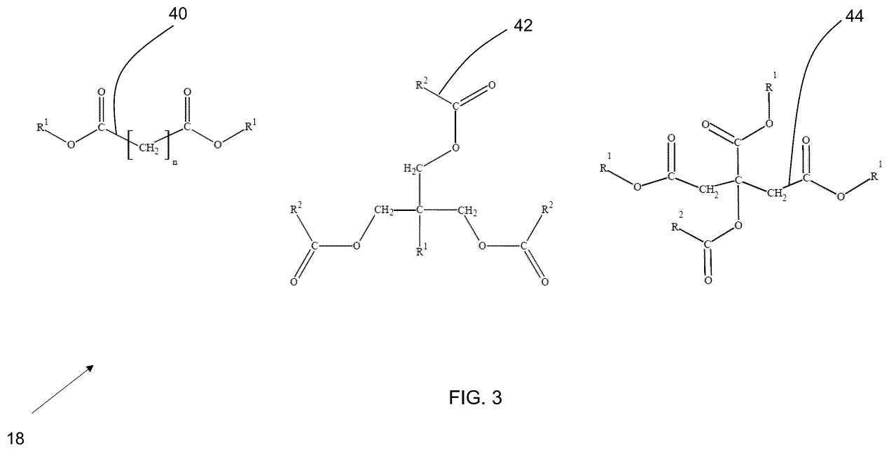

A salient feature of the invention is the solvent 18 used to contact the gaseous stream 12. In an embodiment, the solvent is a physical solvent comprising one or more esters wherein the esters comprise at least two alkyl-ester functional groups on a central hydrocarbon chain. Specifically, the solvent 18 used in the instant invention is an ester or combination of esters selected from esters represented by the general formulae for suitable diesters 40, tri-esters 42, or tetra-esters 44 shown in FIG. 3, wherein 2≤n≤10, and wherein R₁, R₂, and R₃ are alkyl groups having between and including one and six carbons. Suitable and exemplary R groups include methyl, ethyl, propyl, iso-propyl, n-butyl, sec-butyl, or iso-butyl. In an embodiment, whether the solvent 18 is a diester 40, tri-ester 42, or tetra-ester 44, all R groups are the same. In another embodiment, all the R groups are different. In still yet another embodiment, at least two of the R groups of the solvent 18 are the same, wherein, another R group is different than the at least two that are the same.

Embodiments of the invention use neat, pure compounds as solvent 18 (i.e. one ester at a time). In other embodiments one or more esters are combined, the combination used as the solvent 18. In still other embodiments, one or more ester compounds are combined with minor additives to create the solvent 18, wherein the additives do not affect the bulk properties of the solvent, wherein such additives include anti-microbial agents, anti-scaling agents, anti-foaming agents, anti-corrosion additives, and combinations thereof. In yet another embodiment, the solvent 18 comprises at least one of the esters shown in FIG. 2 combined with another CO₂ solvent such as a hydrophobic Poly(ethylene glycol) (PEG)/polydimethylsiloxane (PDMS) solvent, a hydrophobic ionic liquid solvent, another hydrophobic and low pressure solvent, and combinations thereof.

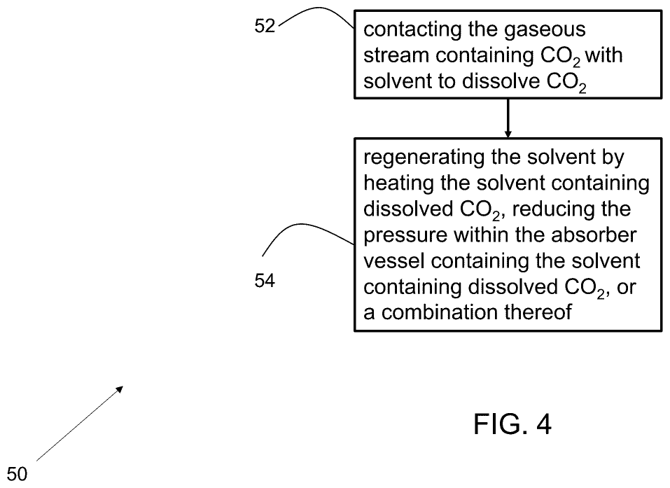

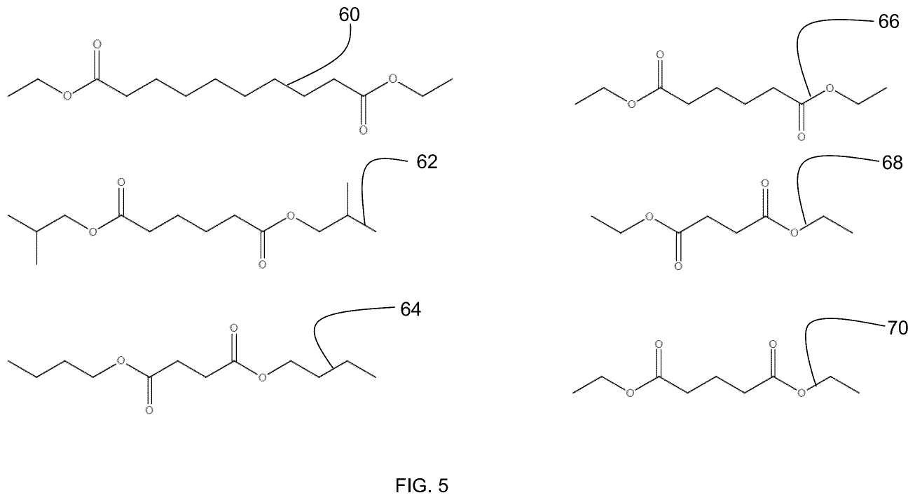

FIG. 4 is a flow chart of a method 50 of using the solvents 18 described herein to remove CO₂ from a gaseous stream 12 by solvating said CO₂ while solvating little to no water. The method 50 begins by contacting 52 the gaseous stream 12 with solvent 18, wherein contacting the gaseous stream 52 with solvent comprises bubbling said gaseous stream 12 through said solvent 18, and wherein the contacting step 52 comprises dissolving the CO₂ previously contained in the gaseous stream 12 into the solvent 18. The contacting step 52 is performed at a first temperature and pressure. The contacting step 52 removes CO₂ from the gaseous stream and leaves a stream of H₂ that may then be combusted. As the solvent 18 used in the method 50 is a physical solvent, said solvent dissolves CO₂ during the contacting step 52 without forming bonds between the solvent 18 and CO₂.

After the contacting step 52, the method continues by regenerating 54 the solvent 18 by heating the solvent containing dissolved CO₂, reducing the pressure within the absorber vessel containing the solvent containing dissolved CO₂, or a combination thereof. The regenerating step 54 of the invented method is performed at a second temperature and pressure.

A salient feature of the present invention is the ability of the contacting step 52 of the invented method to be performed at the first temperature and pressure. Said first temperature and pressure are higher than prior art processes that require cooler temperatures of −40° C. to 10° C. . . . Suitable first temperatures are between approximately −15° C. and approximately 100° C., with typical first temperatures between approximately 20° C. and approximately 50° C. Suitable first pressures are between approximately 5 bar to approximately 100 bar, with typical first pressures between approximately 10 bar to approximately 60 bar. In an embodiment, the first temperature is above approximately room temperature, i.e. above approximately 20° C. As described herein, the first temperature is the initial temperature of the solvent prior to initial contact with the gaseous stream. As described herein, the first pressure is the initial pressure of the gaseous stream prior to initial contact with the solvent.

During the regeneration step 54, the invented method requires a lower second temperature and pressure than prior art methods. In an exemplary embodiment, the suitable second temperatures are between approximately 10° C. to approximately 180° C., with typical second temperatures between approximately 40° C. and approximately 120° C. Suitable second pressures are between approximately 1 bar to approximately 25 bar, with typical second pressures between approximately 5 bar to approximately 15 bar. Given the relatively mild temperatures and pressures used in the regeneration step of the invented method, waste heat or low grade heat is suitable for heating the solvent containing dissolved CO₂ to regenerate said solvent. As described herein, the second temperature is the temperature to which the solvent is heated to remove CO₂. As described herein, the second pressure is the pressure of CO₂ leaving the solvent during the regenerating step.

In order to facilitate use of said higher first temperature and pressure, suitable solvents are needed. The inventors have identified several specific solvents within the generic structures shown in FIG. 3 that are exemplary and suitable solvents for use in the present method. Six exemplary diester solvents are shown in FIG. 5 and are identified by the monikers CASSH-1 60, CASSH-2 62, CASSH-3 64, CASSH-4 66, CASSH-5 68, and CASSH-6 70 herein. Various physical properties of CASSH-1-CASSH-6 are shown below in TABLE 1 along with the names of the CASSH solvents. In TABLE 1, a * denotes a value at 25° C.

TABLE 1

| | | MW, | | Density, | Viscosity, |
|---|---|---|---|---|---|
| Solvent | Name | g/mol | Bp, ° C. | g/mL* | cP* |
| CASSH-1 | Diethyl | 258.35 | 312 | 0.963 | 5.2 |
| | sebacate | | | | |
| CASSH-2 | Diisobutyl | 258.35 | 293 | 0.954 | 5.2 |
| | adipate | | | | |
| CASSH-3 | Dibutyl | 230.30 | 275 | 0.977 | 4.1 |
| | succinate | | | | |
| CASSH-4 | Diethyl | 202.25 | 251 | 1.009 | 3.1 |
| | adipate | | | | |
| CASSH-5 | Diethyl | 174.19 | 218 | 1.047 | 2.6 |
| | succinate | | | | |
| CASSH-6 | Diethyl | 188.22 | 237 | 1.022 | 2.6 |
| | glutarate | | | | |

Another salient feature of the invented method is the ability to separate CO₂ from a gaseous stream that also contains H₂O while absorbing little to no water. In an embodiment, the invented method solvates CO₂ from a gaseous stream also containing H₂O to concentrations equal to or greater than prior art methods. In order to facilitate this feature, the solvents used herein are hydrophobic where current commercial solvents are hydrophilic. In an exemplary embodiment, the invented method solvates between approximately 6.5 mol CO₂ per liter of solvent and approximately 9.0 mole CO₂ per liter of solvent at a solvent temperature of 10° C. and a CO₂ partial pressure of 25 bar or between approximately 4.0 mol CO₂ per liter of solvent and approximately 5.5 mol CO₂ per liter of solvent at a solvent temperature of 25° C. and a CO₂ partial pressure of 25 bar. In an embodiment, the solvent 18 of the instant method has a water solubility of between approximately 0.2 mol/L of H₂O and approximately 2 mol/L of H₂O at 25° C.

Yet another salient feature of the invented method is the CO₂/H₂ selectivity of the method. As the invented method separates CO₂ from pre-combustion syngas streams containing at least H₂ and CO₂ while minimizing the solvation of the H₂, said selectivity ratio is an important feature. In an exemplary embodiment, the CO₂/H₂ of the invented method is greater than approximately 50 and is typically between approximately 60 and approximately 90.

Still another salient feature of the invented method is the low vapor pressure of the solvents utilized. The solvents used in this method are designed specifically to minimize the volatility of said solvents to minimize the cost and difficulty associated with replenishing the solvents and to limit the necessity of separating solvent from gas streams that have been stripped of CO₂. In an exemplary embodiment, the invented method features solvents having a low vapor pressure with boiling points between approximately 180° C. to over 300° C. for diesters with higher boiling points for tri- and tetra-esters.

Still yet another salient feature of the invention is the ability to perform the contacting step 52 of the invented method at elevated temperatures and pressures. Prior art methods require significant cooling and depressurizing of gaseous streams containing CO₂ before contacting said streams with their CO₂ solvent. Conversely, the invented method is suitable for separating CO₂ from gaseous streams having any partial pressure of CO₂ with typical CO₂ partial pressures between approximately 15 bar and approximately 30 bar, and H₂ partial pressures between approximately 5 bar and approximately 35 bar. The gaseous stream may also be saturated with water vapor, with relative humidity varying approximately between 50 and 100%.)

Another salient feature of the invention is the makeup of the solvents used to solvate CO₂. The solvents used in the invented method are comprised of only C, H, and O atoms. Prior art solvents or sorbents require the use of silica, various nitrogen compounds/groups, and/or various fluorine compounds/groups. Any of these non-carbon, hydrogen, or oxygen substances have to be separated from gas streams that will go through a turbine or said turbine will be damaged. As the instant invention does not use any of these non-carbon, hydrogen, or oxygen substances, no step to remove contaminants is needed after CO₂ capture and before the CO₂ scrubbed gaseous stream is put through a turbine.

Still yet another salient feature of the invention is the low corrosive nature of the solvents used. Surprisingly and unexpectedly, empirical testing has demonstrated that the solvents used in the invented method have a corrosion rate of less than around 0.5 microns/year (0.005 mm/year) when a carbon steel or stainless-steel coupon is immersed in the solvent at a temperature of about 21° C. and in the presence of CO₂ at a pressure of 100 psig. In an embodiment, the corrosion caused by use of the instant solvent on carbon or stainless steel is negligible or immeasurable.

Still yet another salient feature of the invention is the low vapor pressure and viscosity of the solvents during performance of the invented method. In an embodiment, the solvents have a vapor pressure between approximately 0.001 Pa and approximately 10 Pa during performance of the instant method. Additionally, the solvents have a viscosity between approximately 1 cP and approximately 15 cP during performance of the invented method.

In an embodiment, the properties of the solvent 18 can be tailored to the conditions of the process utilizing the invented method. For example, low molecular weight, low viscosity solvents such as CASSH-1 to CASSH-6 are particularly suitable for lower temperature applications in the −15° C. to 30° C. range and higher molecular weight (i.e. higher than CASSH-1 to CASSH-6), moderate viscosity solvents are suitable for higher temperature operations in the 30° C. to 70° C. range. Water tolerance can also be tailored to the solvent with water solubilities spanning a range of 0.5-2.5 wt % depending on solvent. The diester 40, tri-ester 42, and tetra ester 44 solvents shown in FIG. 3 and described herein can be tailored to desired application by changing the number of CH₂ units between the ester groups and/or by changing the length and branching of the terminal alkoxy groups on the esters. These modifications affect volumetric CO₂ absorption capacity, solvent melting points, boiling points, vapor pressure, viscosities, and water solubility and as such can be optimized for the demands of the intended application. As an example, increasing the size of the alkyl groups comprising the R groups of the solvent molecules shown in FIG. 3 and described above increases hydrophobicity.

Surprisingly and unexpectedly, the invented method achieves commensurate or superior CO₂ solubility and CO₂/H₂ selectivity compared with state-of-the-art methods while utilizing hydrophobic rather than hydrophilic solvents. As a result, the current method performs as well or better than prior art methods by dissolving superior or commensurate amounts of CO₂ in a stream containing CO₂, H₂, and H₂O wherein the present method uptakes little to no water and has extremely low corrosion rates. Prior art methods utilize hydrophilic solvents that dissolve copious amounts of water along with CO₂ and therefore have many disadvantages detailed above.

### Solvent Preparation Detail

All diesters described herein are commercially available and were purchased from either TCI or Sigma-Aldrich. The tri-ester solvents described herein were derived from commercially available triols such as trimethyol ethane or trimethylol propane and then converted in-house to the corresponding esters via an esterification reaction, wherein the triol is reacted with the appropriate anhydride, preferably acetic, iso-butyric, or n-butyric anhydride. The tetra-esters, also known as citrates, described herein were prepared from either commercially available trialkyl citrates or citric acid which was then functionalized at the three acid sites and the one alcohol site. A procedure to generate the ester solvents disclosed herein is described by Chauhan et al., “Indium Triflate: An Efficient Catalyst for Acylation Reactions,” Synlett, No. 11, 1999, pp. 1743-1744, the entirety of which is incorporated by reference herein.

### Solvent Performance Detail

As discussed herein, the instant method utilizes various ester solvents to dissolve CO₂ from a gaseous stream also containing H₂O. A series of experiments was performed to characterize the performance of the invented method using the above-described solvents.

Gravimetric CO₂ adsorption measurements for solvents were obtained using a Hiden IGA-003 microbalance (Warrington, England). Samples (30-60 mg) were loaded into an open glass container which was suspended from a microbalance assembly inside of a pressure cell. The solvents were outgassed at reduced pressure (10-50 mbar) at 25° C. in flowing N₂ for a minimum of 1 hr prior to introduction of pure to make adsorption measurements.

Isotherms were measured in a thermostatted sample chamber at increasing pressure steps under flowing gas regulated by a mass flow controller and a back pressure regulator. The samples were held at the target pressures until >90% of the equilibrium CO₂ absorption was established (typically 30-90 min). The final CO₂ absorption equilibrium loading was then calculated by an asymptotic fit to the sample weight versus time curve. Buoyancy corrections were applied to the final equilibrium weights using known densities of the samples and all components in the sample and counter weight chambers using gas densities calculated with The National Institute of Standards and Technology's software titled “Reference Fluid Thermodynamic and Transport Properties.” Evaporative losses (determined by the difference in starting weight and final weight at 1 bar) over the course of the measurements were insignificant in relation to the mass increase due to CO₂ adsorption for all of the solvents of interest at the conditions reported herein.

Karl Fischer titrations were performed according to the procedure described in ASTM E203-16 Standard Test Method for Water Using Volumetric Karl Fischer Titration, the entirety of which is incorporated by reference herein.

Henry's law constants were determined by calculating the slope of absorption isotherms at low pressure. The Henry's law constants were used to calculate working CO₂ capacities.

The relative corrosion rates of C1020 carbon were studied under the following conditions: 21° C. and 100 psig CO₂, 21° C. and 400 psig CO₂, 40° C. and 100 psig CO₂, and 40° C. and 400 psig CO₂. The corrosion rates were determined gravimetrically according to ASTM G1-03, Standard Practice for Preparing, Cleaning, and Evaluating Corrosion Test Specimens, the entirety of which is incorporated by reference herein.

### Diester Performance Detail

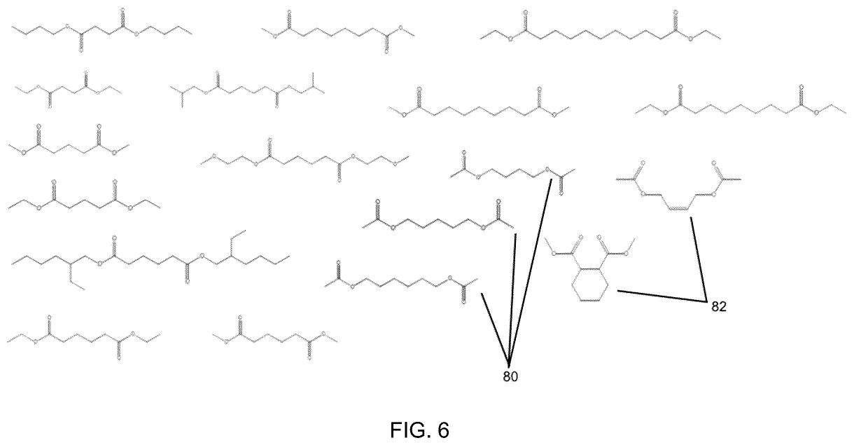

Diethyl sebacate “CASSH-1” was initially identified as a potential high performing CO₂ solvent as described above. Subsequent experimental characterization of CASSH-1 verified its high CO₂ uptake, low H₂ uptake, and low moisture affinity. Guided by these encouraging results, research was expanded and more systematic experimental screening tests for CO₂ solubility in 18 commercially available diester “CASSH” solvents were completed to establish a correlation between molecular structure and volumetric CO₂ uptake. The structures of the 18 diesters that were characterized are shown in FIG. 6.

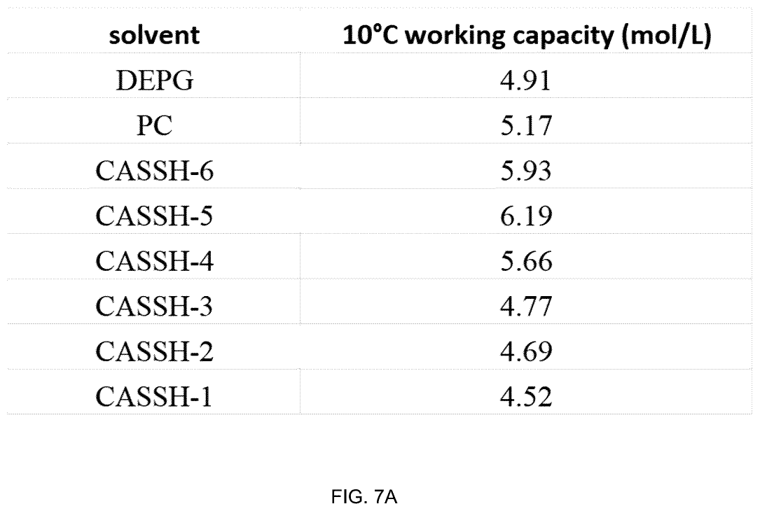

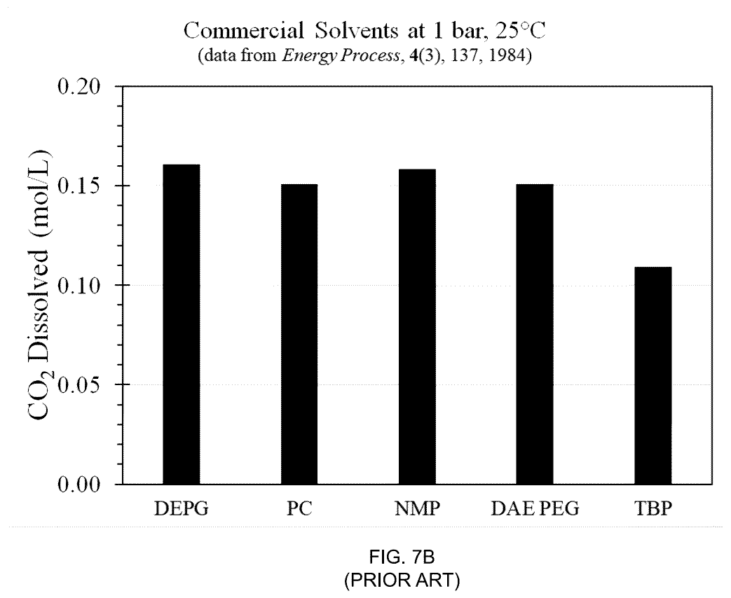

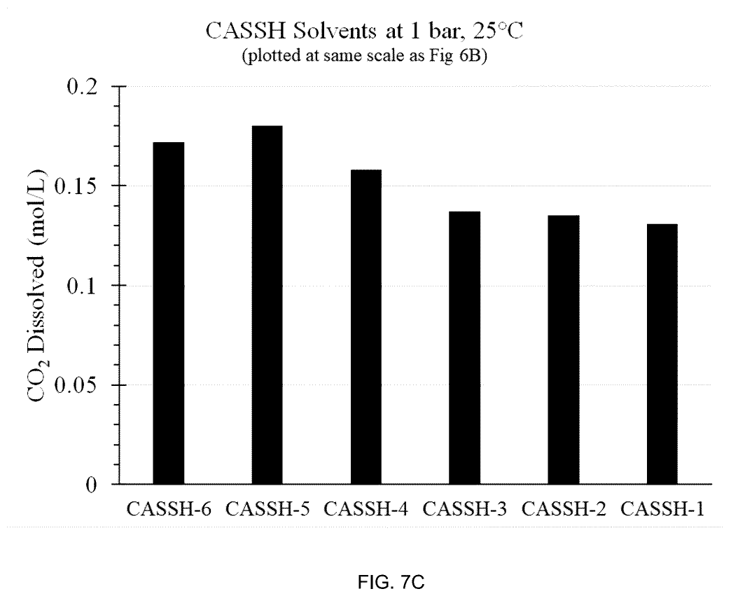

Through the testing of the 18 diesters shown in FIG. 6, it was determined that the six diester CASSH solvents have CO₂ solubilities which are competitive with current commercial solvents while also having physical properties suitable for applications in pre-combustion CO₂ capture applications. The 25° C. Henry's constants and CO₂ working capacities for capture at 20 bar/10° C. with regeneration at 1.5 bar/25° C. for the six solvents, CASSH-1 through CASSH-6 are compared with current commercial solvents in FIGS. 7A-C. The data shown in FIGS. 7A-C demonstrate comparable or superior CO₂ capture properties of the diester solvents to the current commercial solvents tested.

The lower molecular weight solvents CASSH-4, CASSH-5, and CASSH-6 are ideally suited as a CO₂ solvent under chilled gas conditions between approximately −15° C. and approximately 10° C. where CO₂ loading capacity is maximized, and solvent vaporization is negligible. The relatively high boiling points (217° C.-245° C.) of the solvents make them suitable for regeneration near room temperature with minimal evaporation loss. All the CASSH solvents described herein have CO₂ heats of absorption in the range of 14-17 kJ/mol.

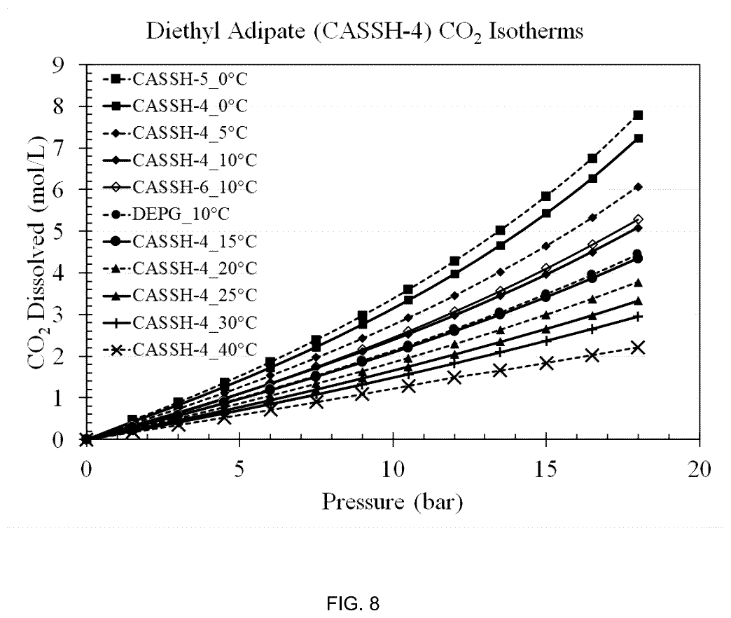

FIG. 8 shows the CO₂ absorption isotherms for CASSH-4 over a range of temperatures between approximately 0° C. to approximately 40° C. The data shown in FIG. 8 exhibit significant enhancement in CO₂ solubility with decreasing temperature as expected for physical solvents. The plotted data also include absorption data for CASSH-5 and CASSH-6 and the two main commercial solvents PC and DEPG at 10° C., a temperature commonly modeled for commercial DEPG systems. All three of the CASSH solvents show improved CO₂ uptake over the commercial solvents. The CO₂ solubility for CASSH-4 at 15° C. matches the DEPG at 10° C. showing the potential to operate at a warmer temperature with similar CO₂ capacity. As systems using DEPG to dissolve CO₂ require solvent temperatures of 10° C., this would reduce the need to chill the solvent by 5° C. if CASSH-4 replaced DEPG in the same system.

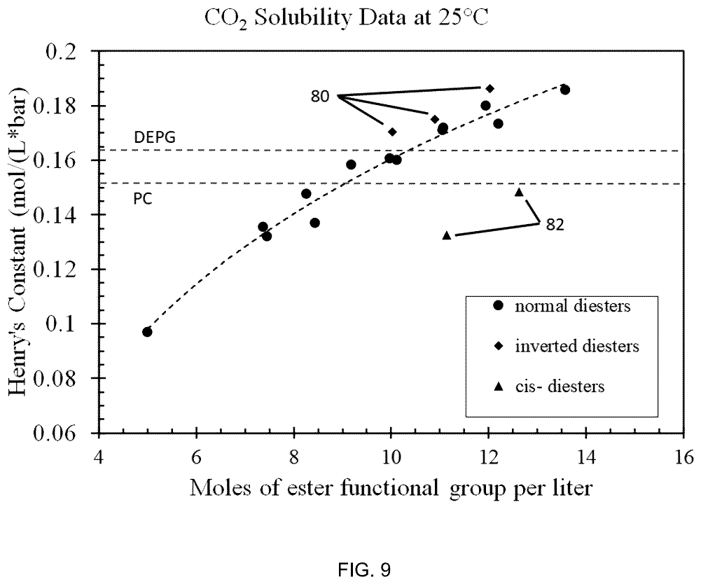

Analysis of the CO₂ solubility data for the solvents shown in FIG. 6 showed a strong correlation between volumetric CO₂ capacity and the concentration of ester groups within a volume of solvent. This correlation is shown in FIG. 9. The data of FIG. 9 shows that the CO₂ uptake of an alkyl diester can be closely estimated from the density and molecular weight of the solvent. As shown by the data in FIG. 9, lower molecular weight solvents with higher densities maximize the concentrations of ester functional groups yielding a higher molar uptake of CO₂ per volume of solvent. The effects of structural variations were also studied by testing “inverted diesters”, which have the ester groups flipped to have the alkoxy oxygen bonded to the internal hydrocarbon chain (structures labeled 80 in FIG. 6) and also derivatives with hindered rotation of the ester groups due to inclusion of either a double bond or ring structure in the molecule (structures labeled 82 in FIG. 6). The hindered rotation in the molecule was shown by the data to be highly detrimental to CO₂ uptake. The inverted esters do show a slight enhancement of CO₂ uptake over the normal diesters. However, costs are higher for these solvents and they tend to have higher melting points.

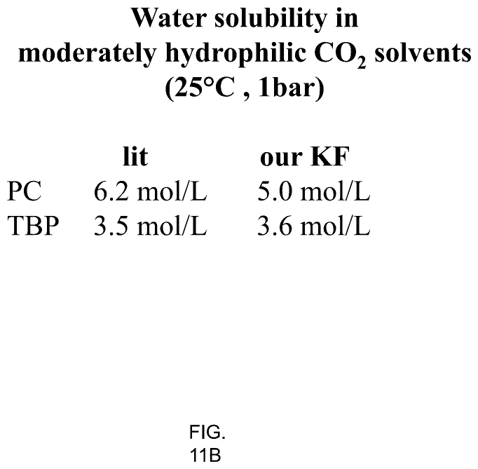

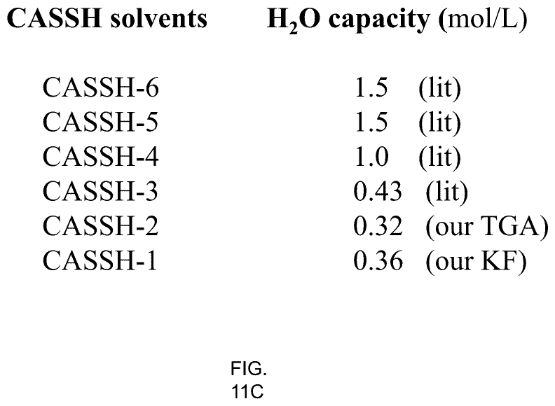

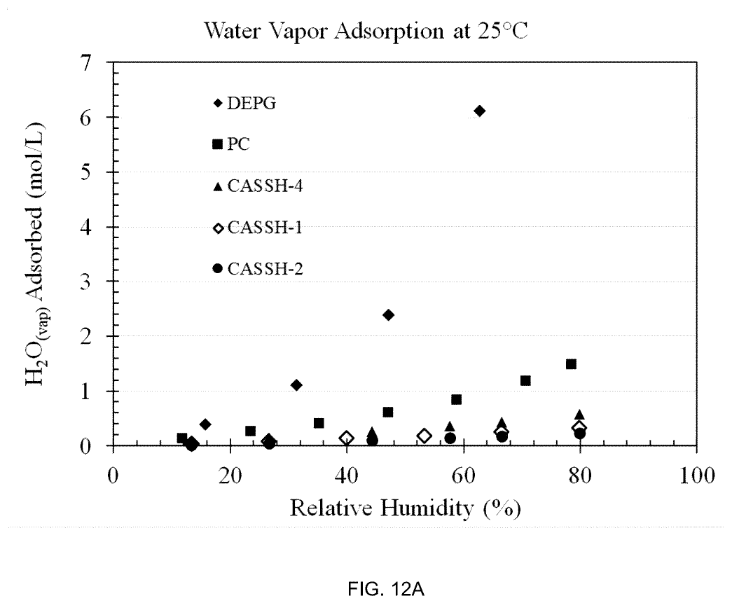

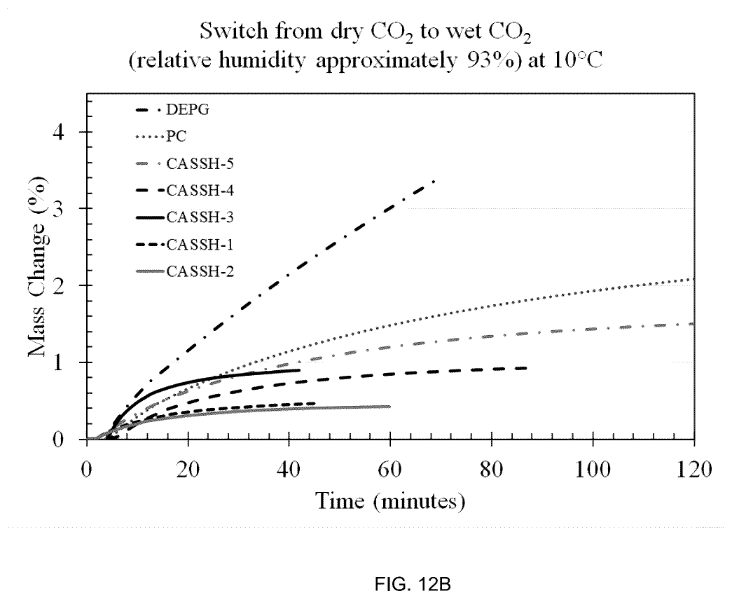

Following the initial experimental CO₂ solubility screening test, additional characterizations of the solvents by water solubility, H₂ solubility (computational models), and physical properties (melting point, boiling point, viscosity) were undertaken. Water absorption tests done using the Karl Fisher titration technique combined with results from the scientific literature for the CASSH series are compared with the most common least hydrophilic commercialized solvents, PC and TBP, with the data shown in FIGS. 11A-C. As shown in FIGS. 11A-C, selected diester solvents in the CASSH series have significantly lower water solubilities than current commercial solvents. Water vapor absorption tests by a gravimetric microbalance using humidified nitrogen show similar results, as shown in FIGS. 12A and 12B. The water solubility in the DEPG is only shown to moderate humidity levels because water vapor absorption at higher humidity is very high with long equilibration times.

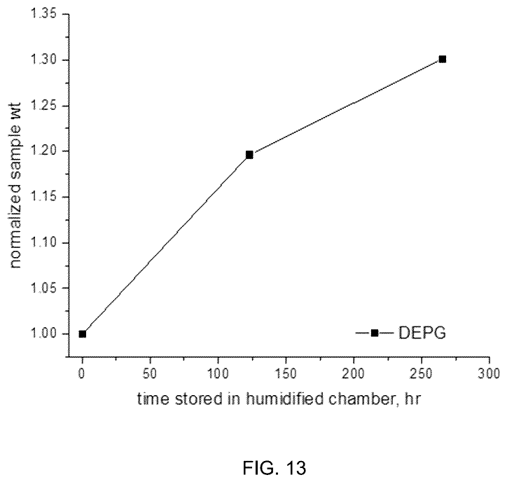

A sample of DEPG was stored in an open vial within a sealed cabinet purged with humidified N₂ over two weeks and the weight of the sample was recorded at intervals with the results shown in FIG. 13. The sample weight increased by 30% in 300 hours and the rate of weight increase had not yet leveled off at that point. FIG. 13 illustrates a salient features of the invented method, very low water adsorption compared to current commercial solvents.

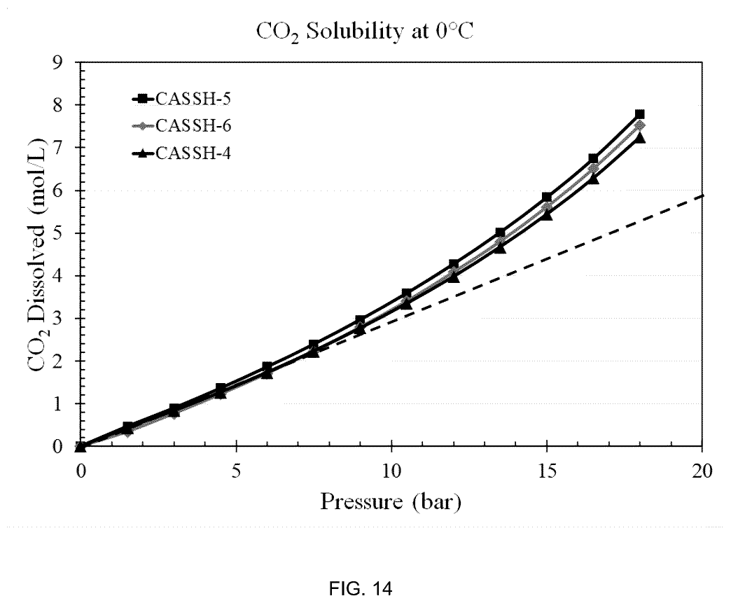

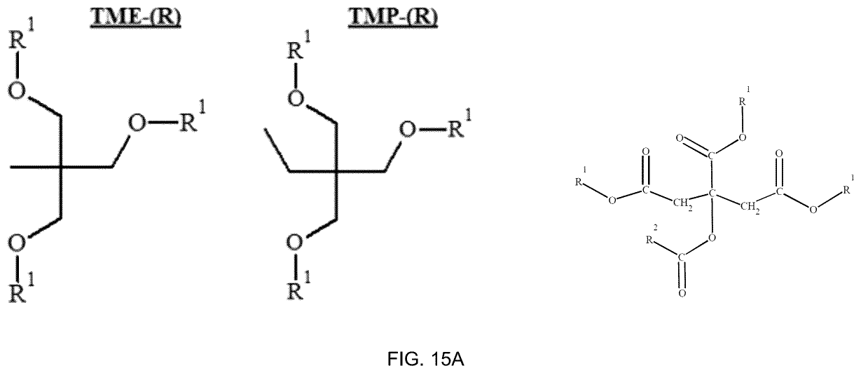

For applications at lower temperatures and higher pressures, CO₂ uptake deviates much more from Henry's Law than does H₂ to give CO₂ isotherms like those in FIG. 14. The pronounced upturn in the CO₂ uptake at high pressure will nearly double the uptake predicted from Henry's Law which in turn will nearly double the working capacity and CO₂/H₂ selectivity of the solvent compared to that from a solvent with a simple linear isotherm.

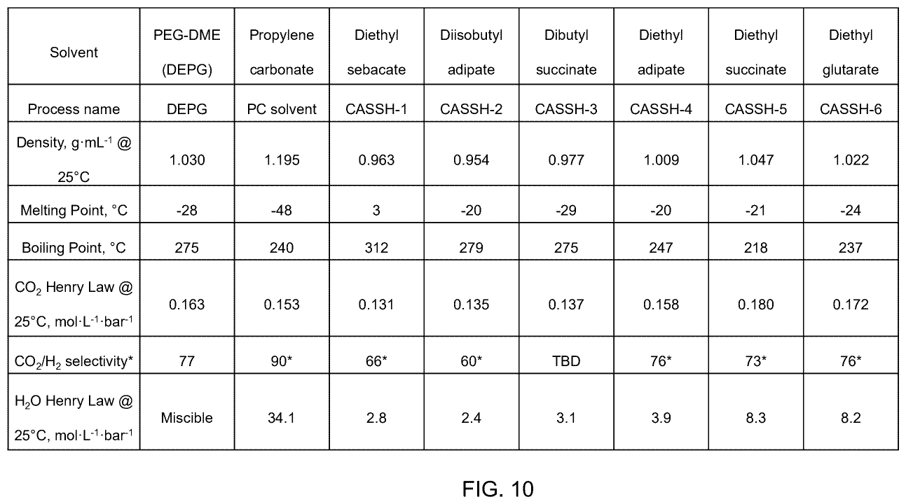

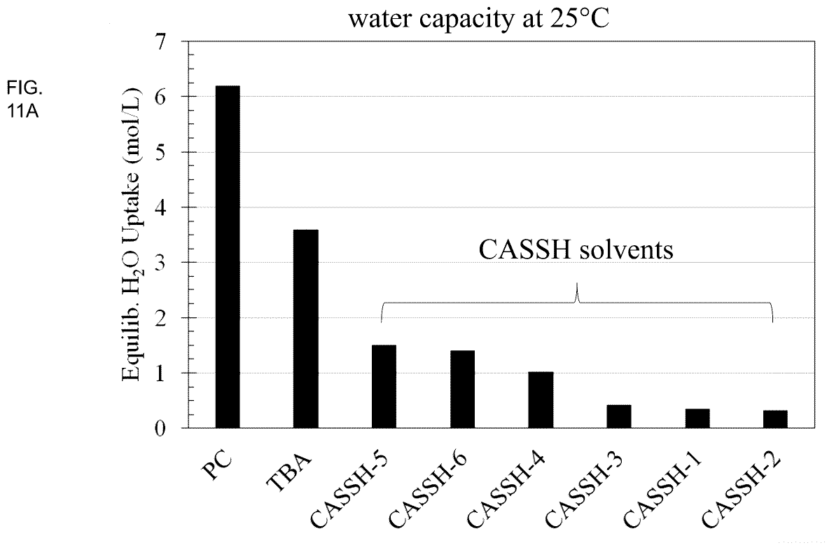

A summary of properties for the CASSH solvents are compared against the commercial solvents PC, which has the most similar properties in terms of CO₂ and water solubility and physical properties, and DPEG. The results are summarized in FIG. 10. The six CASSH solvents listed in FIG. 10 are shown to have similar properties to those of PC but with lower water solubilities. For a low temperature CO₂ capture system working at an absorber temperature of 10° C., all CASSH solvents are highly superior to DEPG due to the large difference in water uptake. For PC, which operates at lower temperatures than DEPG, CASSH 2-6 would be particularly suitable in the range of between approximately −15° C. and approximately 0° C. due to their lower melting points. Mixtures of CASSH solvents could also be applied for absorption processed which operate below 0° C. These mixtures could include other diester derivatives other than those listed as CASSH solvents, for example di-isobutyl succinate or isopropyl glutarate. Importantly, as shown in FIG. 10, the CASSH solvents are superior to current commercial solvents for CO₂ solvation given their unique combination of reduced water absorption, low volatility, and high CO₂ capacities.

While numerous diester derivatives are feasible for capture in the range of between approximately −15° C. and approximately 25° C., derivatives derived from diacids consisting of 4-10 carbons in length with terminal alkyl groups ranging from C1 to C4 are most favored due to factors such as melting points, boiling points, viscosities, and predicted CO₂ uptake based on the correlation shown in FIG. 9.

In an embodiment, it can be determined whether diesters other than those shown and described herein and in the accompanying figures based on where those solvents would land on the correlation plot shown in FIG. 9. Any diester, tri-ester, or tetra-ester with a computed “moles of ester functional group per liter” (computed by EQUATION 1 below) greater than 8 would be predicted to have a competitive CO₂ solubility according to the correlation shown in FIG. 9. The effectiveness of this solvent would then simply be evaluated based on physical properties with optimal values of viscosity (<6 cP), melting point (<5° C.), boiling point (>215° C.), and water solubility (<1.6 mol/L) and material cost to manufacture.

$$moles ester functional group per liter = ( number of ester functional groups in the molecule ) ( density of multiester ) / ( molecular weight of multiester ) \qquad EQUATION 1$$

FIG. 10 provides a table summarizing physical properties and CO₂ solubility parameters for CASSH solvents as compared to commercial solvents PC and DEPG, wherein a * indicates calculated values according to method described in Shi et al., “Computational Screening of Physical Solvents for CO₂ Pre-combustion Capture.” J Phys Chem B. 2021 Dec. 16; 125 (49): 13467-13481, the entirety of which is incorporated by reference herein.

The CO₂/H₂ selectivities listed for CASSH solvents were computed using the relevant Henry's Constants for CO₂ and H₂. These values are expected to be significantly higher under low temperature conditions due to the deviation from Henry's Law for CO₂ uptake. PC results are taken from Burr et al., “Which physical solvent is best for acid gas removal?” Hydrocarbon Processing, 2009, vol. 88, is. 1, pp 43-50 the entirety of which is incorporated by reference herein.

While the above discussion mainly focused on solvents designed for typical process operating conditions in the range of absorber temperatures between approximately −15° C. and approximately 10° C. with CO₂/H₂ mixtures containing CO₂ partial pressures in the range of between approximately 15 and approximately 30 bar and regeneration conditions between approximately 25° C. and approximately 35° C., between approximately 1 bar to approximately 2 bar, initial IGCC-CO₂ capture modeling studies indicate the benefits for operating the absorber at warmer temperatures near approximately 40° C. with higher regeneration temperatures of between approximately 70 and approximately 100° C. using waste heat from a chemical/power plant. The higher operating temperatures in this process would require thermally stable solvents with high boiling points (low vapor pressures) in excess of 275° C. while maintaining low water uptake and low viscosities. Of the widely used commercial solvents, only DEPG or TBP would meet the boiling point and stability requirements. However, as noted above, DEPG is very hydrophilic and would suffer greatly under the higher water partial pressures at 40° C. compared to those at 10° C. For these proposed warm gas operations, CASSH-1 and CASSH-2 would be suitable diester solvents due to their high CO₂ uptake and extremely low water solubility, with CASSH-3 also an option.

### Tri-Ester and Tetra Ester

### Characterization and Performance Detail

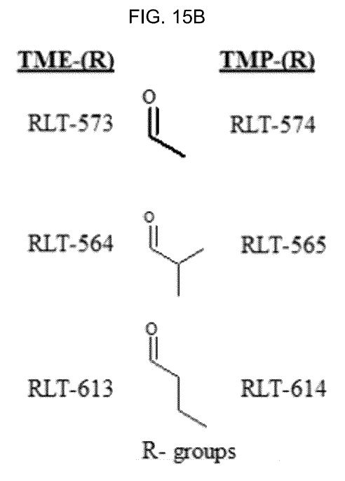

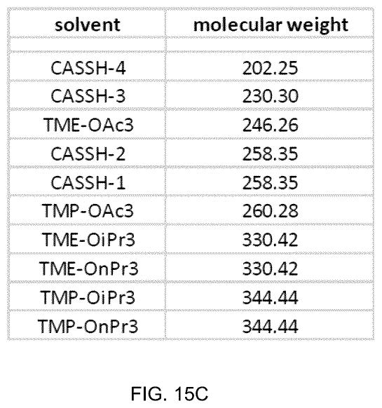

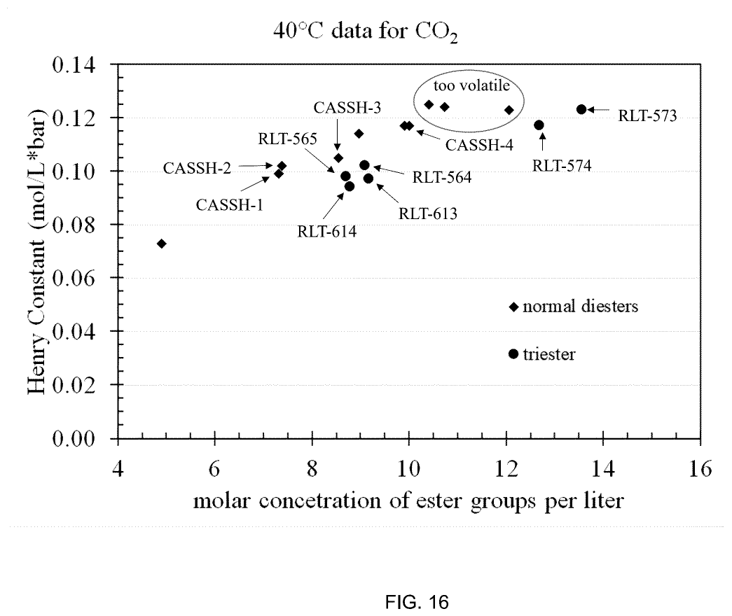

As described above and shown in FIG. 3, an embodiment of the invention uses tri- and tetra esters as CO₂ solvents in the invented method. These multi-ester molecules are particularly suitable for warm gas operations. Exemplary multi-esters (more than two) are shown in FIGS. 15A-C which are derived by transesterification of either trimethylolethane or trimethylolpropane, respectively. These higher molecular weight solvents provide low vapor pressure options with “moles of ester functional group per liter” values in the favorable region of the correlation plot shown in FIG. 16.

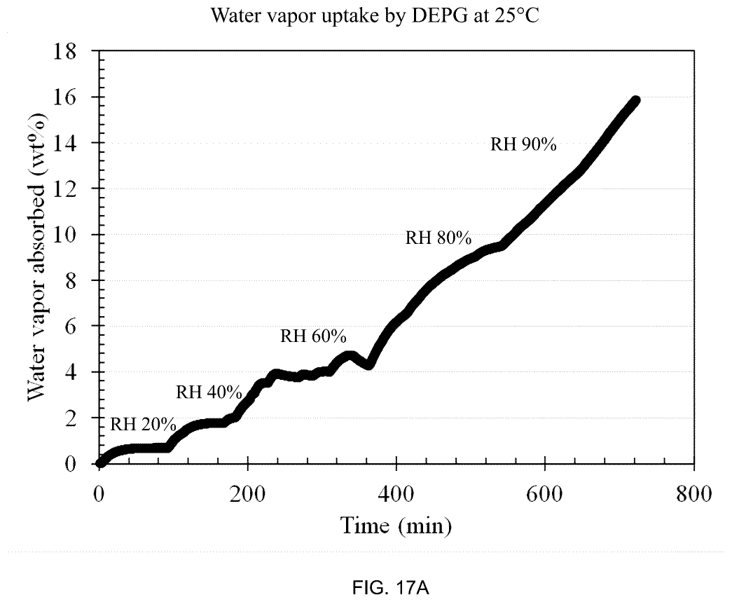

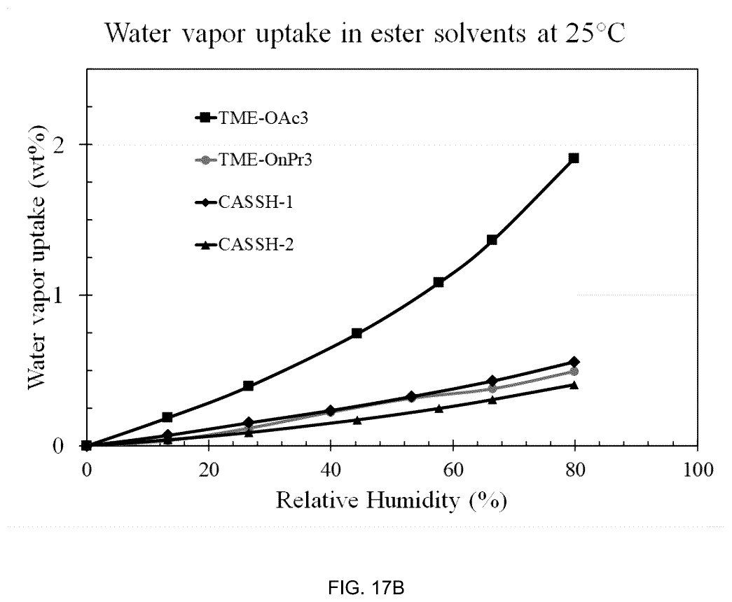

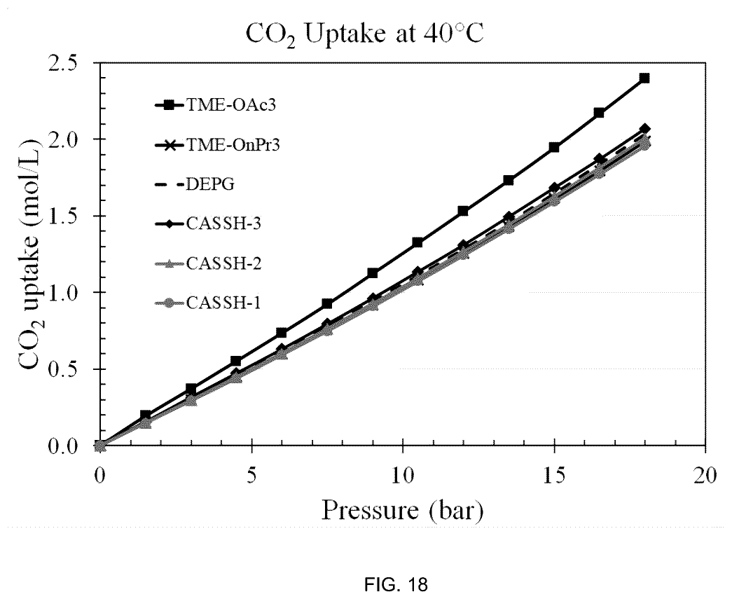

Tri-ester and citrate solvents can be tailored in a similar fashion to the diester CASSH solvents to optimize their CO₂ capacity and other physical properties. The plots in FIGS. 17A-17B and FIG. 18 show the water mitigation and competitive CO₂ capture of tri-esters TME-OAc₃ and TME-OiPrs as well as CASSH-1 and CASSH-2. The water uptake in these solvents is exceptionally low compared to the DEPG and significantly lower than that of the most hydrophobic commercial solvent TBP. Tri-ester TME-OAC₃ is the lowest molecular weight tri-ester. It is the least hydrophobic tri-ester, but shows the highest CO₂ uptake and significantly outperforms DEPG while maintaining a water uptake lower than TBP. The hydrophobicity of the tri-ester can be enhanced by adding carbons to the ester groups. Replacing the methyl groups of tri-esters TME-OAc₃ with isopropyl groups gives TME-OiPr₃ which shows very low water vapor absorption while maintaining a CO₂ uptake at 40° C. which is nearly identical to that of DEPG and TBP. As observed for the diester solvents, the tri-ester solvents also possess high CO₂/H₂ absorption selectivity. In fact, the CO₂/H₂ selectivity of 83 for TME-OAc₃ (calculated using the method in Shi et al., “Computational Screening of Physical Solvents for CO₂ Pre-combustion Capture.” J Phys Chem B. 2021 Dec. 16; 125(49):13467-13481) is among the highest of the solvents shown in TABLE 3. The high molecular weights of tri-ester solvents along with CASSH-1 and CASSH-2 diesters provide the low vapor pressures required for efficient operation at elevated temperatures relative to tradition chilled gas capture.

FIG. 16 is plot for some diester and tri-ester solvents which shows the correlation of 40° C. CO₂ Henry's constants to the molar concentration of ester functional groups within a liter of the pure solvents. As shown in FIG. 16, While tri-esters are slightly below the correlation of diesters, they have an advantage of good capacity at 40° C. with very low vapor pressure.

### Pilot Testing Detail

Pilot scale testing was performed by the Energy & Environmental Research Center at the University of North Dakota (UND EERC) by shipping solvents to their precombustion capture facility and testing at the pilot scale. Flow and gas make-up parameters for the pilot scale testing is shown in TABLE 2 below. TABLE 3 provides pilot testing performance data for various solvents.

TABLE 2
Average shifted syngas conditions and composition
entering absorber column for each trial

| Parameter | Value |
|---|---|
| Syngas total pressure, MPa | 4.88 |
| Syngas temperature, ° C. | 37.5 |
| Syngas flow rate, std. m³ · h⁻¹ | 3.8 |
| Syngas composition, dry, avg (mol %) | |
| CO₂ | 52.0 |
| H₂ | 13.1 |
| N₂ | 32.7 |
| CH₄ | 1.6 |
| CO | 0.2 |
| H₂S | 0.5 |

TABLE 3
Pilot plant campaign at UND EERC solvent absorption performance results for DEPG,
PEG-PDMS-3, CASSH-1 and TBP at high solvent flow rates (approx. 37-45 L/hr).

| Solvent | Performance | | PEG- | | |
|---|---|---|---|---|---|
| Temperature* | parameter | PEGDME | PDMS-3 | CASSH-1 | TBP |
| 10° C. | Solvent temperature | 10.1-13.8 | 9.5-20.5 | 10.4-28.5 | 10.7-13.9 |
| | inlet-outlet, ° C. | | | | |
| | CO₂ gas uptake, | 1.64 ± 0.10 | 1.72 ± 0.10 | 2.27 ± 0.03 | 1.50 ± 0.06 |
| | mol × L − 1 | | | | |
| | H₂S gas uptake, | 0.014 ± 0.001 | 0.014 ± 0.001 | 0.021 ± 0.001 | 0.015 ± 0.001 |
| | mol × L − 1 | | | | |
| 25° C. | Solvent temperature | 25.0-27.0 | 25.3-33.6 | 25.6-32.6 | 25.1-26.8 |
| | inlet-outlet, ° C. | | | | |
| | CO₂ gas uptake, | 1.46 ± 0.14 | 1.63 ± 0.02 | 1.66 ± 0.04 | 1.65 ± 0.04 |
| | mol × L − 1 | | | | |
| | H₂S gas uptake, | 0.011 ± 0.001 | 0.012 ± 0.001 | 0.015 ± 0.001 | 0.016 ± 0.001 |
| | mol × L − 1 | | | | |
| 40° C. | Solvent temperature | ** | 40.0-46.6 | 40.6-48.0 | 39.8-41.4 |
| | inlet-outlet, ° C. | | | | |
| | CO₂ gas uptake, | ** | 1.64 ± 0.07 | 1.91 ± 0.05 | 1.90 ± 0.01 |
| | mol × L − 1 | | | | |
| | H₂S gas uptake, | ** | 0.014 ± 0.001 | 0.018 ± 0.001 | 0.018 ± 0.001 |
| | mol × L − 1 | | | | |
| 55° C. | Solvent temperature | ** | 54.3-63.7 | 55.4-57.4 | 55.5-58.5 |
| | inlet-outlet, ° C. | | | | |
| | CO₂ gas uptake, | ** | 1.55 ± 0.10 | 1.67 ± 0.05 | 1.92 ± 0.01 |
| | mol × L − 1 | | | | |
| | H₂S gas uptake, | ** | 0.014 ± 0.001 | 0.016 ± 0.001 | 0.018 ± 0.001 |
| | mol × L − 1 | | | | |

| | | | | |
|---|---|---|---|---|
| Water content of solvent at | 4000 | 550 | 1550 | 1670 |
| end of trial, ppm | | | | |

For the pilot testing whose data is shown in TABLE 3, CO₂ partial pressure in syngas was ˜2.6 MPa and H₂S partial pressure in syngas was ˜0.02 MPa. For 10° C.-25° C. inlet cases, the solvent was regenerated at 43° C. For the 40-55° C. inlet cases, the solvent was regenerated at approximately the temperature that it leaves the absorption column, no additional heat was supplied if the solvent was already greater than 43° C.

In TABLE 3, a * indicates that An absorber temperature range is provided for each nominal solvent temperature. The lower temperature is the absorber inlet solvent temperature (solvent enters at the top of the absorption column) and the higher temperature is the solvent temperature at the bottom of the absorption column. As the syngas enters at approximately 38° C. and the absorption process is exothermic, there is a temperature gradient from the top to bottom of the column. PEGDME solvent testing was not conducted at the highest solvent inlet temperature of 55° C. and data was not included if mass balance errors were greater than 20% (which was the case for data collected with PEGDME at 40° C.).

### Corrosion Detail

A final, but significant advantage of the instant invention applications is its anticipated effect on reducing corrosion rates. Corrosion rate models were calculated using OLI software package for carbon steel are shown in TABLE 4. There is a dramatic decrease in corrosion rate predicted as the water content in the solvent is decreased. Even a relatively hydrophilic solvent such as DEPG shows a marked decrease in corrosion rates over aqueous solutions of K₂CO₃ and methyldiethanolamine (MDEA) due to lower water concentrations. When the solvent becomes even more hydrophobic as with the CASSH series of solvents, the corrosion rate drops many orders of magnitude below DEPG, and well below the ideal rate of 0.01 mm/yr. With a predicted corrosion rate of practically zero, hydrophobic solvents will provide exceptional benefits to preserving process infrastructure against degradation and produce substantial savings in initial construction and yearly maintenance costs.

TABLE 4

| | H₂O | K₂CO₃ in H₂O | wet MDEA |
|---|---|---|---|
| With 1% H₂S | 0.85 | 0.21 | 0.852 |
| Without 1% H₂S | 25.6 | 0.08 | 0.70 |

TABLE 4 depicts the calculated corrosion rate of carbon steel at 40° C. in equimolar CO₂/H₂ at 50 bar (in mm/yr). Models were performed using OLI software package on generic carbon steel. Ideal corrosion rate is <10 μm/yr, though <50 μm/yr can be acceptable for many applications.

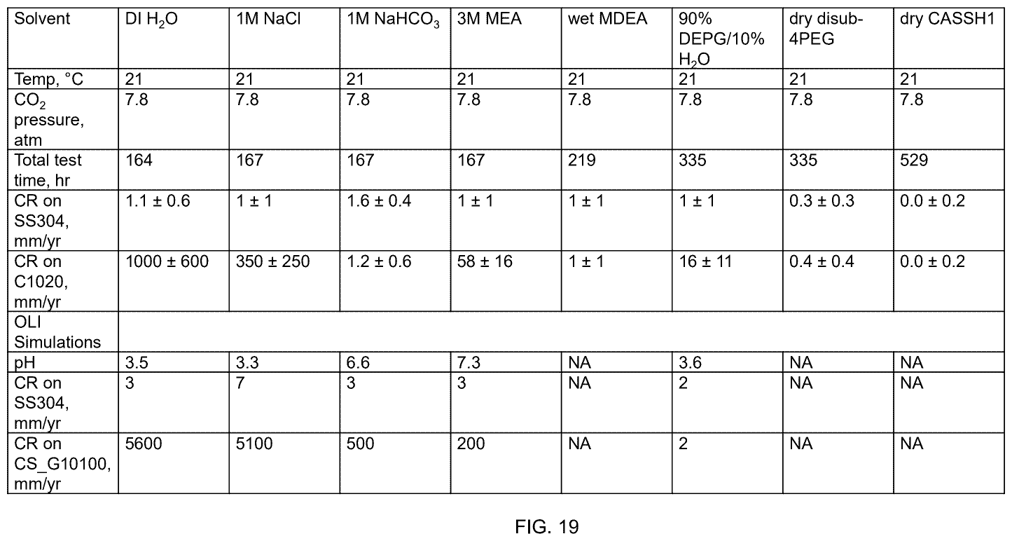

Corrosion data has been collected for CASSH-1, the data provided in FIG. 19. As shown in FIG. 19, corrosion was not detected in testing with CASSH-1 even though the tests with CASSH-1 were allowed to run longer than every other solvent.

FIG. 19 provides the corrosion rates measured for carbon and stainless steels using various pre-combustion solvents, as calculated by OLI software. It is found that the hydrophobic CASSH solvent shows greatly reduced corrosion rates compared solvents which contain or admit water.

The measured corrosion rates in FIG. 19 reflect the average (and standard deviation) of two methods (gravimetric and spectroscopic) for stainless steel SS304 and general carbon steel C1020. OLI Corrosion Analyzer simulations of the corrosion rate for those cases which could be simulated used SS304 and carbon steel C10100. The solvent disub-4PEG was disclosed previously by the inventors in U.S. Pat. No. 10,589,228, the entirety of which is incorporated by reference herein.

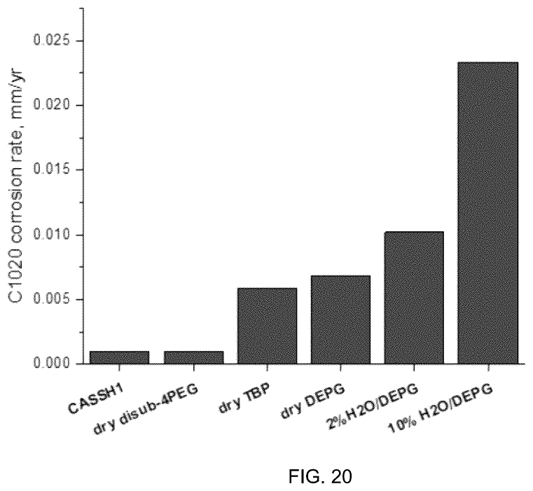

The relative corrosion rates of C1020 carbon steel in the presence of CASSH-11, dry DEPG, and DEPG containing only 2 wt. % water was studied under the following conditions: 21° C. and 100 psig CO₂, 21° C. and 400 psig CO₂, 40° C. and 100 psig CO₂, and 40° C. and 400 psig CO₂. The corrosion rates were determined gravimetrically according to ASTM G1-03, Standard Practice for Preparing, Cleaning, and Evaluating Corrosion Test Specimens. The rates obtained are illustrated in FIG. 20, where dry CASSH-1 and dry disub-4PEG show superior corrosion rates to dry TBP, dry Poly(ethylene glycol) dimethyl ether (DME PEG), and DME PEG with 2% H₂O and 10% H₂O added. The moisture content experienced by carbon capture solvents may easily exceed these nominal levels under actual capture conditions. The ability to use carbon steel in place of stainless steel for capture system equipment would result in substantial capital cost reductions.

The solvents used in the invented method are superior to solvents used in the prior art. The presently used solvents 18 are low in viscosity, hydrophobic, low in vapor pressure, and high in CO₂/H₂ absorption selectivity, and low in water solubility, for example. The solvents are well suitable to remove CO₂ from a stream of syngas that has gone through the water gas shift, i.e. remove CO₂ from a combined stream of CO₂, H₂ and H₂O. As physical solvents, the solvents described herein are suitable for a combined temperature swing/pressure swing operation in the exemplary temperature range between approximately −15° C. to approximately 100° C. with exemplary CO₂ partial pressures in the range of approximately 15 to approximately 30 bar during absorption and between approximately 10° C. and approximately 180° C. and between approximately 1 to approximately 25 bar for regeneration.

The solvents described herein have superior properties in certain aspects over prior art solvents and also share beneficial or necessary properties of prior art solvents to aid in dissolving CO₂ in the invented method as described above. For example, the solvents described herein have similar boiling points, viscosities, and CO₂ and H₂ solubilities as common commercial solvents used in similar applications, but with significantly lower water solubilities. The disclosed solvents are also stable under the intended operating conditions and have environmental advantages including low toxicity, high biodegradability, and do not contain any chemical elements other than H, C, or O that can cause turbine damage if any solvent should make its way into the combustion process.

Considering the aforementioned advantages and disadvantages of PC, NMP, and DEPG, it is apparent that a hydrophobic solvent with similar physical properties which can operate at low temperatures with comparable CO₂ solubility could offer significant benefits as a CO₂ mitigation solvent. The current invention addresses this need through the development of hydrophobic CO₂ physical solvents.

Another embodiment relates to a method for removing CO₂ from a gaseous stream containing CO₂. The method includes contacting the gaseous stream containing CO₂ with a solvent at a first temperature and a first pressure to dissolve said CO₂ in said solvent, wherein the solvent includes a tri-ester similar to that of FIG. 3 for example, wherein R₁ and R₂ are alkyl groups having between and including one and six carbons.

In one embodiment, the gaseous stream containing CO₂ comprises products from a syngas-generating process selected from the group of gases consisting of CO₂, CO, H₂, and H₂O. The gaseous stream may contain CO₂ and/or comprises H₂ and H₂O. Embodiments may include the solvent having a water capacity of between approximately 0.2 mol/L of H₂O and approximately 2 mol/L of H₂O at 25° C., wherein the solvent can have a CO₂/H₂ selectivity at 25° C. between approximately 60 and approximately 90.

Embodiments include that the solvent is hydrophobic. The solvent may have a CO₂ solubility between approximately 6.5 mol CO₂ per liter of solvent and approximately 9.0 mol CO₂ per liter of solvent. Additional embodiments may include the solvent has a viscosity between approximately 1 cP and approximately 15 cP while the gaseous stream containing CO₂ contacts the solvent. The solvent may have a CO₂/H₂ selectivity greater than 50. The solvent may have a CO₂/H₂ selectivity between approximately 60 and approximately 90. Additionally, the solvent may have a boiling point between approximately 180° C. and approximately 300° C.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the terms “about” or “approximately,” whether or not explicitly indicated. The terms “about” or “approximately” generally refer to a range of numbers that one of skill in the art would consider equivalent to the recited value (e.g., having the same function or result). In many instances, the terms “about” and “about” include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method for removing CO₂ from a gaseous stream containing CO₂ comprising: contacting the gaseous stream containing CO₂ with a solvent at a first temperature and a first pressure to dissolve said CO₂ in said solvent, wherein the solvent comprises at least one ester, selected from the group of esters consisting of 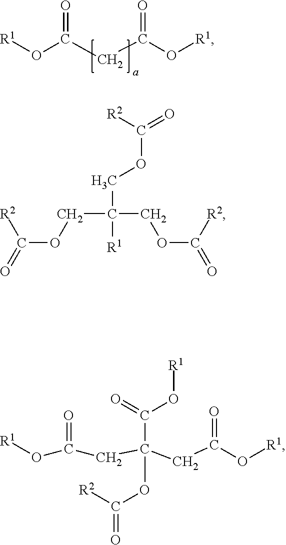
and combinations thereof,
wherein 2<n≤10, and wherein R₁ and R₂ are alkyl groups having between and including one and six carbons.

2. The method of claim 1 wherein the solvent is a diester selected from the group consisting of diethyl sebacate, diisobutyl adipate, diethyl adipate, diethyl glutarate, and combinations thereof.

3. The method of claim 1 wherein the first temperature is between approximately −15° C. and approximately 100° C. and, and wherein the first pressure is between approximately 5 bar and approximately 100 bar.

4. The method of claim 1 wherein the gaseous stream containing CO₂ comprises products from a syngas-generating process selected from the group of gasses consisting of CO₂, CO, H₂, and H₂O.

5. The method of claim 1 wherein the gaseous stream containing CO₂ also comprises H₂ and H₂O.

6. The method of claim 6 wherein the solvent has a water capacity of between approximately 0.2 mol/L of H₂O and approximately 2 mol/L of H₂O at 25° C.

7. The method of claim 6 wherein the solvent has a CO₂/H₂ selectivity at 25° C. between approximately 60 and approximately 90.

8. The method of claim 1 further comprising regenerating the solvent by at least one of reducing the pressure of the solvent to a second pressure and heating the solvent to a second temperature, wherein regenerating the solvent results in CO₂ leaving the solvent.

9. The method of claim 8 wherein the solvent is heated using waste heat.

10. The method of claim 8 wherein the second temperature is between approximately 10° C. and approximately 180° C., and wherein the second pressure is between approximately 1 bar to approximately 25 bar.

11. The method of claim 1 wherein the solvent has a corrosion rate of less than around 0.005 mm/year when a carbon steel or stainless steel coupon is immersed in the solvent at a temperature of about 21° C. and in the presence of CO₂ at a pressure of 100 psig.

12. The method of claim 1 wherein the gaseous stream contains CO₂ at a partial pressure between approximately 15 bar and approximately 30 bar.

13. The method of claim 1 wherein the solvent is a physical solvent, and wherein contacting the gaseous stream containing CO₂ with a solvent results in CO₂ dissolved in the solvent without bonds formed between the CO₂ and solvent.

14. The method of claim 1 wherein the solvent is hydrophobic.

15. The method of claim 1 wherein the solvent has a CO₂ solubility between approximately 6.5 mol CO₂ per liter of solvent and approximately 9.0 mol CO₂ per liter of solvent.

16. The method of claim 1 wherein the solvent has a viscosity between approximately 1 cP and approximately 15 cP while the gaseous stream containing CO₂ contacts the solvent.

17. The method of claim 1 wherein the solvent has a CO₂/H₂ selectivity greater than 50.

18. The method of claim 17 wherein the solvent has a CO₂/H₂ selectivity between approximately 60 and approximately 90.

19. The method of claim 1 wherein the solvent has a boiling point between approximately 180° C. and approximately 300° C.

20. A method for removing CO₂ from a gaseous stream containing CO₂ comprising: contacting the gaseous stream containing CO₂ with a solvent at a first temperature and a first pressure to dissolve said CO₂ in said solvent, wherein the solvent comprises: 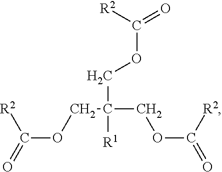
and wherein R₁ and R₂ are alkyl groups having between and including one and six carbons.

21. The method of claim 20 wherein the gaseous stream containing CO₂ comprises products from a syngas-generating process selected from the group of gasses consisting of CO₂, CO, H₂, and H₂O.

22. The method of claim 21 wherein the gaseous stream containing CO₂ also comprises H₂ and H₂O.

23. The method of claim 22 wherein the solvent has a water capacity of between approximately 0.2 mol/L of H₂O and approximately 2 mol/L of H₂O at 25° C.

24. The method of claim 23 wherein the solvent has a CO₂/H₂ selectivity at 25° C. between approximately 60 and approximately 90.

25. The method of claim 21 wherein the solvent is hydrophobic.

26. The method of claim 21 wherein the solvent has a CO₂ solubility between approximately 6.5 mol CO₂ per liter of solvent and approximately 9.0 mol CO₂ per liter of solvent.

27. The method of claim 21 wherein the solvent has a viscosity between approximately 1 cP and approximately 15 cP while the gaseous stream containing CO₂ contacts the solvent.

28. The method of claim 21 wherein the solvent has a CO₂/H₂ selectivity greater than 50.

29. The method of claim 28 wherein the solvent has a CO₂/H₂ selectivity between approximately 60 and approximately 90.

30. The method of claim 21 wherein the solvent has a boiling point between approximately 180° C. and approximately 300° C.

31. A method for removing CO₂ from a gaseous stream containing CO₂ comprising: contacting the gaseous stream containing CO₂ with a solvent at a first temperature and a first pressure to dissolve said CO₂ in said solvent, wherein the solvent comprises: 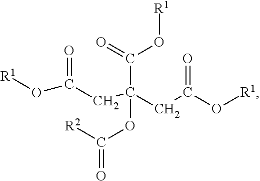
and wherein R₁, R₂, and R₃ are alkyl groups having between and including one and six carbons.

32. The method of claim 31 wherein the gaseous stream containing CO₂ comprises products from a syngas-generating process selected from the group of gasses consisting of CO₂, CO, H₂, and H₂O.

33. The method of claim 31 wherein the gaseous stream containing CO₂ also comprises H₂ and H₂O.

34. The method of claim 33 wherein the solvent has a water capacity of between approximately 0.2 mol/L of H₂O and approximately 2 mol/L of H₂O at 25° C.

35. The method of claim 34 wherein the solvent has a CO₂/H₂ selectivity at 25° C. between approximately 60 and approximately 90.

36. The method of claim 31 wherein the solvent is hydrophobic.

37. The method of claim 31 wherein the solvent has a CO₂ solubility between approximately 6.5 mol CO₂ per liter of solvent and approximately 9.0 mol CO₂ per liter of solvent.

38. The method of claim 31 wherein the solvent has a viscosity between approximately 1 cP and approximately 15 cP while the gaseous stream containing CO₂ contacts the solvent.

39. The method of claim 31 wherein the solvent has a CO₂/H₂ selectivity greater than 50.

40. The method of claim 31 wherein the solvent has a CO₂/H₂ selectivity between approximately 60 and approximately 90.

41. The method of claim 31 wherein the solvent has a boiling point between approximately 180° C. and approximately 300° C.
